(19) United States
(12) Patent Application Publication
(10) Pub. No.: US 2008/0318674 A1
(43) Pub. Date: Dec. 25, 2008

(54) Game Apparatus and Game Control Method

(75) Inventors: Hirotake Nakano, Tokyo (JP); Masaru Kohayakawa, Tokyo (JP)

Correspondence Address: IPUSA, P.L.L.C, 1054 31ST STREET, N.W., Suite 400, Washington, DC, 20007, US

(73) Assignee: SEGA CORPORATION

(21) Appl. No.: 12/138,540

(22) Filed: Jun. 13, 2008

(30) Foreign Application Priority Data
Jun. 22, 2007 (JP) 2007-165595

(51) Int. Cl. A63F 9/24; A63F 13/06

(52) U.S. Cl. 463/31; 463/43

(57) ABSTRACT

A game apparatus displays a first image being provided with a hit determining area, and a second image being superimposed on the first image to hide the first image. The first image is caused to appear by erasing pixels of the second image corresponding to a specified position coordinate or a predetermined area containing the specified position coordinate or applying a transparent process to the pixels, when the specified position coordinate is located within the hit determining area and when the second image exists at the position coordinate. A determination is made that the game ended in success when the area of the visually recognizable portion of the first image exceeds a predetermined ratio. A determination is made that a game ended in failure when the operation amount parameter reaches the predetermined threshold value before the area of the visually recognizable portion of the first image reaches the predetermined ratio.

### BACKGROUND OF THE INVENTION

1. Field of the Invention

The present invention relates to game apparatuses and, more particularly, to a game apparatus which may be used in conjunction with a video and/or audio playback device and/or a video display device having a function controllable remotely from the device.

2. Description of the Related Art

As one of genres of video games, there is a game of a type in which at least one item is hidden in a place in a predetermined area of a screen so that a player finds the hidden item. In this kind of game, for example, a player touches a portion of the screen where the player thinks that the item to be found is hidden. If the player can touch the portion where the item is hidden within a predetermined time period or within a predetermined number of times of try, the item appears on the screen and a score point corresponding to the item is given.

On the other hand, in the Role Playing Game (RPG) or the like, a chance to obtain an item, which can be used in a match-up or a deal later in the game, is provided in various scenes. In this kind of game, the item is hidden at a place within a game space where it is difficult to find the item, and a player can obtain the item by moving a game character which the player operates.

As explained above, it is a main purpose for the conventional game to merely find a place where an item is hidden. Once a player find an item, the player has a sense of satisfaction that he or she was able to find and acquire the hidden item, but there is no opportunity to think about the acquired item. That is, the game producers spend time and labor on creation of item images to attract attention of the player, but there is less ingenuity to attract the player's attention to the item itself while the player is playing the game. Thus, it is said that there is no effect obtained that matches the labor of the game producers.

Moreover, because a player's skill as to how much the player knows about an item is seldom influenced in acquiring the item, the player pays less attention to the item itself in that point of view.

### SUMMARY OF THE INVENTION

It is a general object of the present invention to provide a novel and useful game apparatus in which the above-mentioned problems are eliminated.

A more specific object of the present invention is to provide a game apparatus which can provide a game in which good knowledge about configurations of items appearing in the game leads to a high score so that player's attention is paid to the items while playing the game, thereby prompting the player to remember the configuration of each item.

In order to achieve the above-mentioned objects, there is provided according to one aspect of the present invention a game apparatus comprising: a display screen that displays a first image and a second image, the first image being provided with a hit determining area, the second image being superimposed on the first image to hide the first image, a position coordinate specifying part that receives an operation input of a player and specifies a position coordinate designated by the operation input; a visual recognition processing part that causes the first image to appear by erasing pixels of the second image corresponding to the specified position coordinate or a predetermined area containing the specified position coordinate or applying a transparent process to the pixels, when the specified position coordinate is located within the hit determining area and when the second image exists at the position coordinate; a parameter changing part that changes an operation amount parameter based on an amount of a moving operation of a position coordinate designating operation performed by the player; a parameter determining part that determines whether the operation amount parameter reaches a predetermined threshold value; a ratio determining part that determines whether an area of a visually recognizable portion of the first image exceeds a predetermined ratio of an area of the entire hit determining area; a success determining part that determines that a game ended in success when the area of the visually recognizable portion of the first image exceeds the predetermined ratio; and a failure determining part that determines that a game ended in failure when the operation amount parameter reaches the predetermined threshold value before the area of the visually recognizable portion of the first image reaches the predetermined ratio.

The game apparatus according to the present invention may further comprise a display part that displays a gauge indicating a ratio of a current value to an initial value of the operation amount parameter. The game apparatus may further comprise a rank giving part that gives a rank to a result of the game based on a determination as to whether a ratio of a current value of the operation amount parameter to the initial value of the operation amount parameter is greater than a predetermined value. The rank giving part may give a rank based on a determination as to whether an exposure ratio of the hit determining area of the first image is larger than a predetermined value when a determination is made that the game ended in failure.

The game apparatus according to the present invention may further comprise an initial capacity level setting part that sets an initial capacity level to a character or an item which appears in a subsequent play of the game in accordance with a level of success at a time of ending the game. The game apparatus may further comprise an item giving part that gives to the player an item which provides an advantage in playing a subsequent game in accordance with a level of success at a time of ending the game.

In the game apparatus according to the present invention, at least one predetermined portion of the second image may be partially removed beforehand so that a corresponding part of the first image located under the second image is exposed through the removed predetermined portion. The first image may be an image of a fossil of a dinosaur and the second image may be an image of a rock, and wherein an operation by the player may be related to scraping the rock by a pick.

There is provided according to another aspect of the present invention a game control method comprising: displaying a first image and a second image, the first image being provided with a hit determining area, the second image being superimposed on the first image to hide the first image; receiving an operation input of a player and specifying a position coordinate designated by the operation input; causing the first image to appear by erasing pixels of the second image corresponding to the specified position coordinate or a predetermined area containing the specified position coordinate or applying a transparent process to the pixels, when the specified position coordinate is located within the hit determining area and when the second image exists at the position coordinate; changing an operation amount parameter based on an amount of a moving operation of a position coordinate designating operation performed by the player; determining whether the operation amount parameter reaches a predetermined threshold value; determining whether an area of a visually recognizable portion of the first image exceeds a predetermined ratio of an area of the entire hit determining area; determining that a game ended in success when the area of the visually recognizable portion of the first image exceeds the predetermined ratio; and determining that a game ended in failure when the operation amount parameter reaches the predetermined threshold value before the area of the visually recognizable portion of the first image reaches the predetermined ratio.

Additionally, there is provided according to another aspect of the present invention a computer readable recording medium storing a program to cause a computer to function as a game apparatus performing the above-mentioned game control method.

Further, there is provided according to another aspect of the present invention a computer readable program to cause a computer to function as a game apparatus performing the above-mentioned game control method.

According to the present invention, the knowledge about a form of an item appearing in the game leads to a high score. Thus, the player's attention is directed to the item appearing in the game, thereby prompting the player to memorize the form of the item.

Other objects, features and advantages of the present invention will become more apparent from the following detailed description when read in conjunction with the accompanying drawings.

### BRIEF DESCRIPTION OF THE DRAWINGS

FIG. 1 is a diagram showing a configuration of a game apparatus according to an embodiment of the present invention;

FIG. 2A is an illustration of contents of a data table used for processing;

FIG. 2B is an illustration of a data structure of a state hold table;

FIG. 3A is an illustration of a form of a fossil;

FIG. 3B is an illustration of an arrangement of images in a display state;

FIG. 4 is an illustration of small square elements;

FIG. 5A is an illustration of an original form of a side-facing fossil;

FIG. 5B is an illustration of the fossil form of FIG. 5A reversed in a horizontal direction;

FIG. 5C is an illustration of the fossil form of FIG. 5A reversed in a vertical direction;

FIG. 5D is an illustration of the fossil form of FIG. 5A reversed both in a horizontal direction and a vertical direction;

FIG. 5E is an illustration of an original form of a front-facing fossil;

FIG. 5F is an illustration of the fossil form of FIG. 5E reversed in a horizontal direction;

FIG. 5G is an illustration of the fossil form of FIG. 5E reversed in a vertical direction;

FIG. 5H is an illustration of the fossil form shown in FIG. 5E reversed both in a horizontal direction and a vertical direction;

FIG. 6 is an illustration of an example of display of a gauge;

FIG. 7 is a flowchart of a process performed by a game apparatus according to the embodiment of the present invention;

FIG. 8A is an illustration of a screen initially displayed on a main monitor and an operation part monitor;

FIG. 8B is an illustration of the screen displayed subsequent to the display of FIG. 8A;

FIG. 9 is an illustration of the screen when starting cleaning;

FIG. 10A is an illustration of the screen in which a success effect is performed on a portion scraped by a pick;

FIG. 10B is an illustration of the screen where a dust generation has been performed;

FIG. 10C is an illustration of the screen where a dust removal has been performed;

FIG. 11A is an illustration of the screen of the operation part monitor in a case where the cleaning ended in success; and

FIG. 11B is an illustration of the screen of the operation part monitor in a case where the cleaning ended in failure.

### DETAILED DESCRIPTION OF THE PREFERRED EMBODIMENT

A description will now be given of a preferred embodiment of the present invention.

Although a game apparatus according to an embodiment of the present invention provides a game of scraping or cleaning an item, which is an image of a dinosaur fossil, out of a rock by using a tool called as a pick, the item used in the game according to the present invention is not limited to-such an image of a dinosaur fossil and items based on other theme, such as, for example, an image of an insect contour, a geographic image of a state, a county or a city, etc., may be used.

<System Configuration>

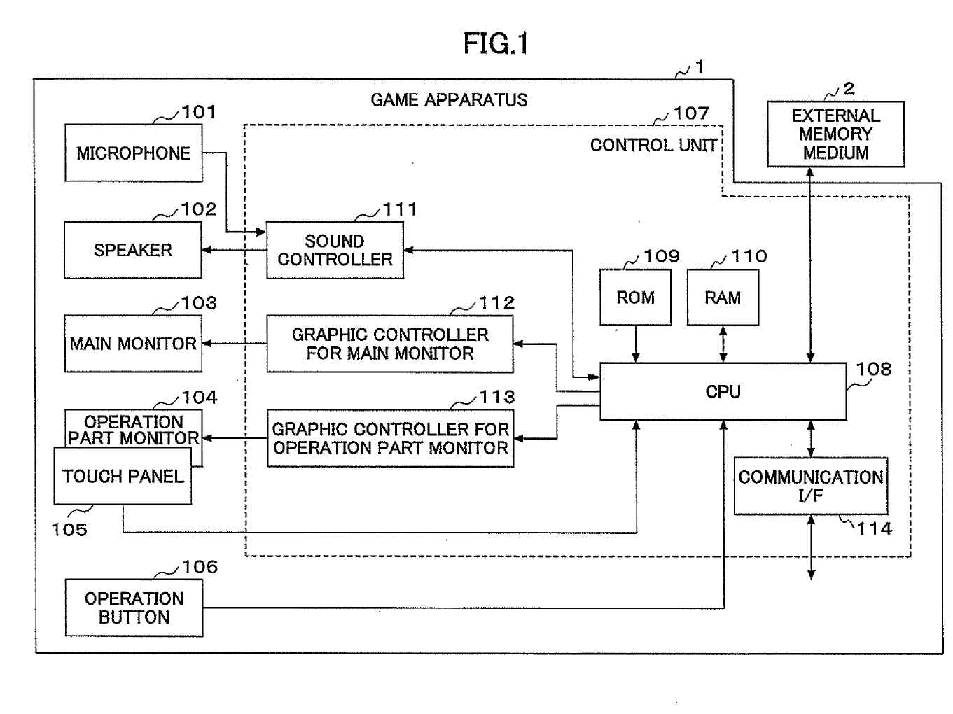

FIG. 1 is a diagram showing a configuration of a game apparatus according to an embodiment of the present invention.

As shown in FIG. 1, the game apparatus 1 according to the embodiment of the present invention is provided with a microphone 101 for audio input, a speaker 102 for audio output, a main monitor 103 for displaying a portion of an image or graphical contents of the game, an operation part monitor 104 having a touch panel 105 for displaying a part of the image or graphical contents of the image and receiving an operation input of a player, an operation button 106 for receiving an operation input of the player, and a control unit 107 for controlling each part. The game apparatus 1 is configured to be attached with an external memory medium 2, such as a game cassette, a memory card, a compact disc (CD), a digital versatile disc (DVD), etc.

The control unit 107 comprises a central processing unit (CPU) 108 for performing a main process, a read only memory (ROM) 109 for storing fixed programs and sets of data, and a random access memory (RAM) 110 serving as a software working area. The control unit 107 further comprises a sound controller 111, a graphic controller 112 for main monitor, a graphic controller 114 for operation part monitor, and a communication interface (I/F) 114. The sound controller 111 performs an audio input from a microphone 101 and an audio output to a speaker 102 under a control of the CPU 108. The graphic controller 112 performs an image display on the main monitor 103 under a control of the CPU 108. The graphic controller 113 for operation part monitor performs an image display on the operation part monitor 104 under a control of the CPU-108. The communication I/F 114 connects the CPU 108 to external devices. Additionally, signals input through the touch panel 105 and the operation button 106 are supplied to the CPU 108.

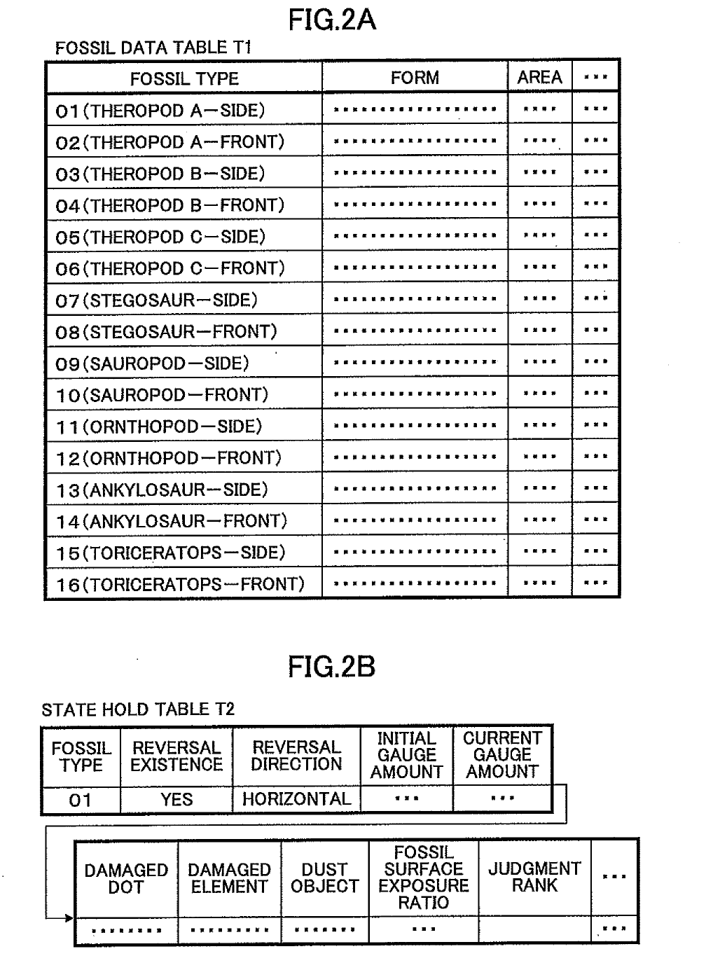

FIG. 2A shows a fossil data table T1 used for processing, FIG. 2B shows a data structure of a state hold table T2. The fossil data table T1 and the state hold table T2 are stored in the RAM 110 of the control unit 107 or the external memory medium 2.

The fossil data table T1 shown in FIG. 2A contains a “fossil type” field, a “form” field, and an “area” field.

The “fossil type” field represents a type of a fossil to which an ID, which can distinguish fossil types or corresponding internal expression data, is set. With regard to fossils of the same dinosaur (for example, “theropod A”), a side view (for example, “theropod A-side”) and a front view (for example, “theropod A-front”) are set as different fossil types. In the fossil data table T1, a total of sixteen fossil types are set with side and front views of eight kinds of dinosaurs.

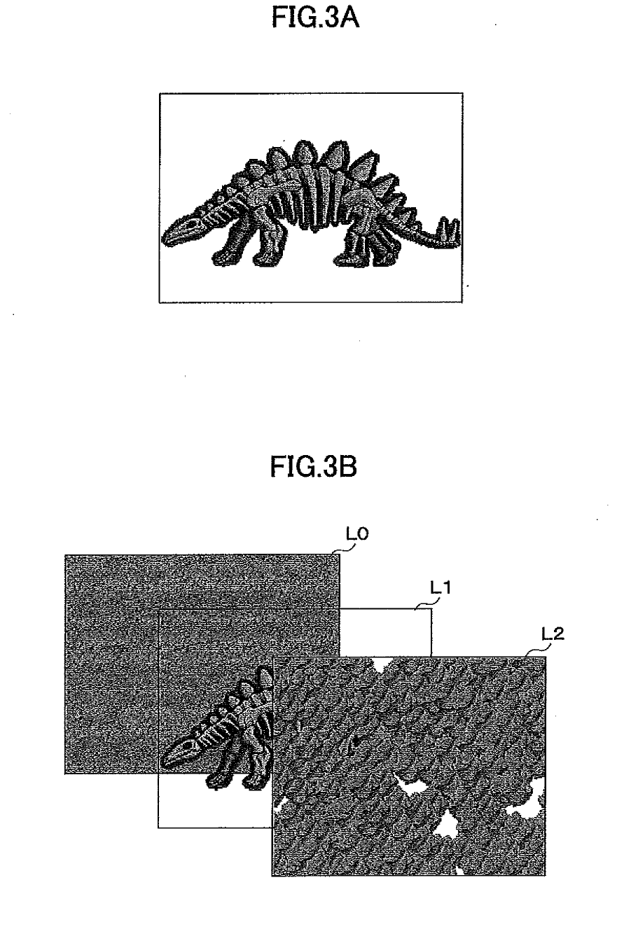

The “form” field represents data of a form of each fossil and a link to an image data main part representing a form or an image data main part is set, FIG. 3A is an illustration showing a form of a fossil. The form shown in FIG. 3A corresponds to a side view of the fossil. Portions representing an effective form are set as hit determination areas, and other portions are set as transparent areas. FIG. 3B is an illustration showing an arrangement of images in a display state. In FIG. 3B, a background layer L0 displaying a background image, a fossil layer L1 displaying a form of a fossil, and a rock layer L2 displaying a rock part covering the surface of the fossil are superimposed one on another in that order. By gradually removing the rock image by scraping the rock layer L2, the form of the fossil hidden in the lower layer is exposed gradually, and, thereby, the fossil can be visually recognized.

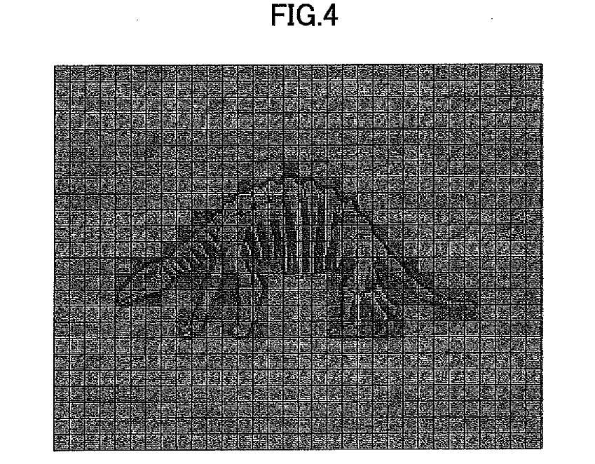

Returning to FIG. 2A, the “area” field represents an area of the fossil. The display screen is divided into small square elements each having a predetermined size (for example, 8 dots×8 dots) in a grid pattern. The “area” field indicates a number of small square elements corresponding to the fossil. FIG. 4 is an illustration showing the small square elements. A number of small square elements that contains a portion of the fossil is set as the area of the entire fossil. Hereinafter, the small square element may be simply referred as an element.

The state hold table T2 shown in FIG. 2B contains a “fossil type” field, a “reverse existence” field, a “reverse direction” field, an “initial gauge amount” field, a “current gauge amount” field, a “damaged dot” field, a “damaged element” field, a “dust object” field, a “fossil surface exposure rate” field, and a “judgment rank” field.

The “fossil type” field represents a currently selected type of fossil, which is one of values indicated in the “fossil type” field of FIG. 2A and determined at the time of starting the game. For example, when a fossil item, which is an object to be subjected to cleaning while a main game is progressing, a cleaning game is started. In such a case, a type of fossil is determined based on a random or scenario progress or a growth level of a player character, information regarding a place where the fossil item is captured, and the determined type is set in the “fossil type” field.

The “reverse existence” field represents an existence of reverse on the display of the form of the fossil. “Yes” or “No” or internal expression data corresponding to those is set in the “reverse existence” field.

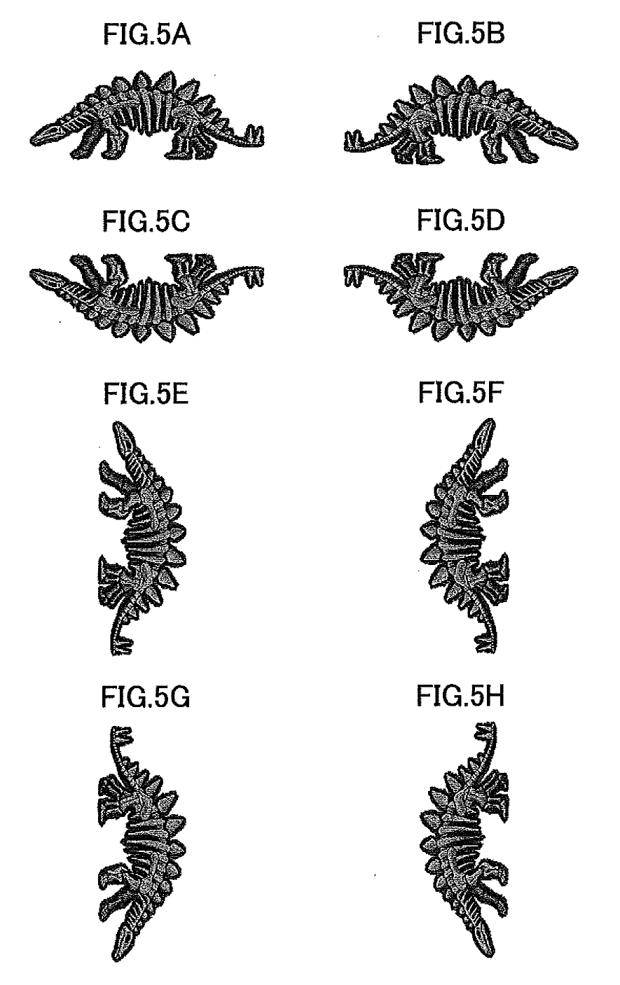

The “reverse direction” field represents a reverse direction of the form of the fossil. “Horizontal”, “Vertical”, “Horizontal and Vertical” or internal expression data corresponding to those is set in the “reverse direction” field. FIG. 5A is an illustration showing an original form of a side-facing fossil. FIG. 5B is an illustration showing the fossil form of FIG. 5A reversed in a horizontal direction. FIG. 5C is an illustration showing the fossil form of FIG. 5A reversed in a vertical direction. FIG. 5D is an illustration showing the fossil form of FIG. 5A reversed both in a horizontal direction and a vertical direction. Similarly, FIG. 5E is an illustration showing an original form of a front-facing fossil. FIG. 5F is an illustration showing the fossil form of FIG. 5E reversed in a horizontal direction. FIG. 5G is an illustration showing the fossil form of FIG. 5E reversed in a vertical direction. FIG. 5H is an illustration showing the fossil form shown in FIG. 5E reversed both in a horizontal direction and a vertical direction.

Returning to FIG. 2B, the “initial gauge amount” field represents a durability value of a pick used for scraping a rock part or an initial value of a damage value. The durability value of the pick or damage value is an operation amount parameter, which changes according to an amount of use (operation) of the pick. The “initial gauge amount” is an initial value of the operation amount parameter. A value in the “initial gauge amount” field is obtained from a reference value, which is a multiple of an area (number of small squire elements) of a fossil and the dot size of each small square element (for example, 8 dots×8 dots=64 dots). In order to obtain the value in the “initial gauge amount”, the reference value is multiplied by a ratio (for example, 83%) of an exposure threshold value at which a cleaning process ends in success, and further multiplied by a spare power factor (for example, 1.3).

The “current gauge amount” field represents the durability value of the pick or the current value of the damage value. Strictly, the value should be decremented by 1 each time a rock part corresponding to 1 dot is scraped by the pick. However, since a display resolution of the gauge is not so high, the reduction is made by the number of dots of each small square element each time the small square element, which is not damaged, is scraped.

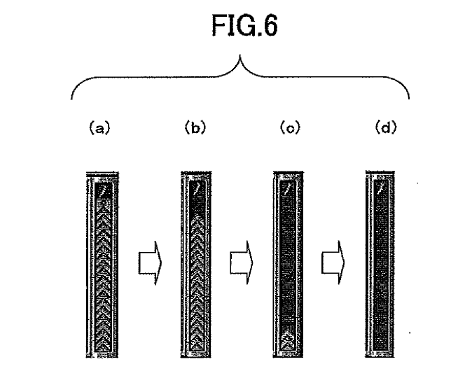

A ratio of the current gauge amount to the initial gauge amount is indicated as a gauge. FIG. 6 is an illustration of an example of display of the gauge. FIG. 6-(a) indicates a state where the gauge amount is full. The gauge amount decreases as indicated in FIG. 6-(b), FIG. 6-(c) and FIG. 6-(d) in that order. FIG. 6-(d) indicates a state where the gauge amount is zero.

Returning to FIG. 2B, the “damage dot” field represents dots corresponding to the rock part scraped by the pick.

The “dust object” field represents a kind and a display position (may be a plurality of positions) of an image object of dust generated each time a part of the rock part corresponding to a predetermined number of dots (for example, 120 dots) is scraped. As kinds of the dust object, four patterns may be used, including two kinds of texture (large and small) and also two kinds of scale. It should be noted that the dust object cannot be removed by a pick input, but can be removed by an audio input through an audio input means, an operation input through a cross key or a button, or a detection of a vibration of more than a predetermined frequency by a vibration detecting means provided to the housing of the game apparatus. In the present embodiment, the dust object itself is not included in the criteria of judgment of success in the cleaning, but the dust object provides an effect of increasing fun in playing the game by causing a fossil image to be hardly recognized visually. However, according to a difficulty level setting of the game, a removal of the dust object may be included in the criteria of the judgment of success in the cleaning.

The “fossil surface exposure ratio” field represents a ratio of an exposure area on the fossil to an area of the entire fossil. The “judgment rank” field represents results to be judged based on the fossil surface exposure ratio and the current gauge amount immediately before an end of the game. According to the judgment rank, an initial value of a capacity can be set when using a dinosaur restored from the cleaned fossil as a character or an item in the game.

<Operation>

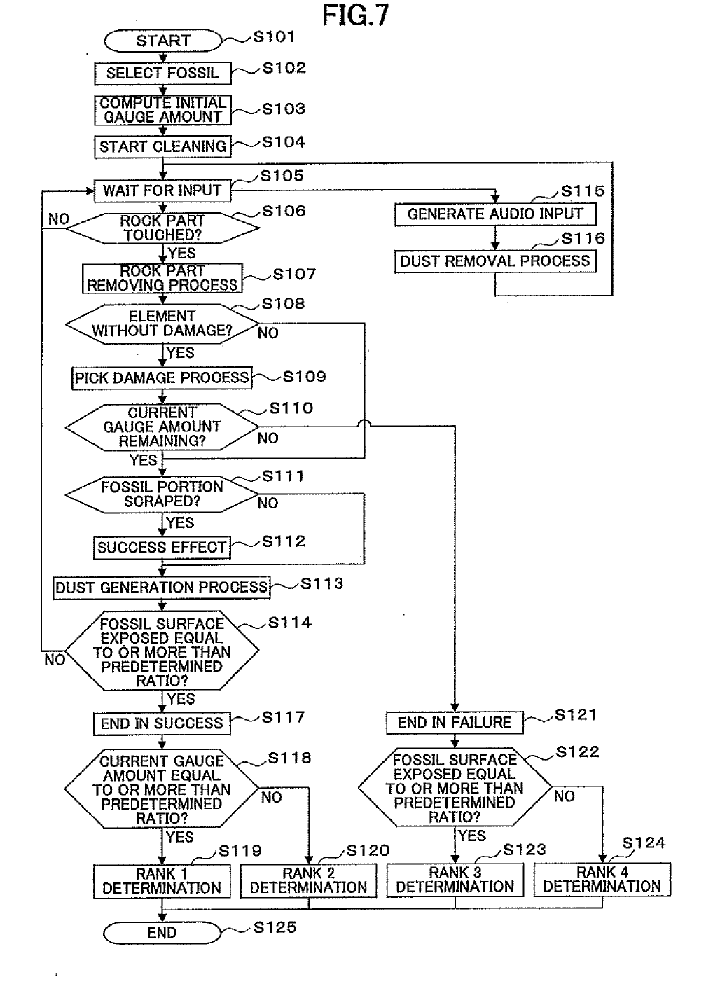

FIG. 7 is a flowchart of a process performed by the game apparatus according to the present embodiment.

In FIG. 7, when the process is started by starting the game (step S101), a fossil type is selected from the fossil data table T1 of FIG. 2A and an existence of reverse (reversal existence) and a direction of the reverse (reversal direction) are determined according to a control of a program executed by the CPU 108 (step S102). The selected fossil type, the determined reversal existence and the determined reversal direction are set to the “fossil type” field, the “reversal existence” field and the “reversal direction” field of the state hold table T2 of FIG. 2B, respectively.

Subsequently, the CPU 108 computes an amount of initial gauge of the pick based on the area (the number of elements) of the selected fossil type, and sets the computed initial gauge amount to the “initial gauge amount” field and the “current gauge amount” field of the state hold table T2 (step S103). Specifically, the initial gauge amount IG of the pick is computed by the following equation:

IG=FA×DS×ER×SPF

where FA is a fossil area (a number of small square elements);

DS is a dot size of each element, which is, for example, 64 dots if the element consists of 8 dots×8 dots;

ER is a ratio of the exposure threshold value determined as success in cleaning (for example 83%); and

SPF is a factor of a spare power (for example, 1.3).

Subsequently, the CPU 108 causes the main monitor 103 and the operation part monitor 104 to display a cleaning start screen (step S104).

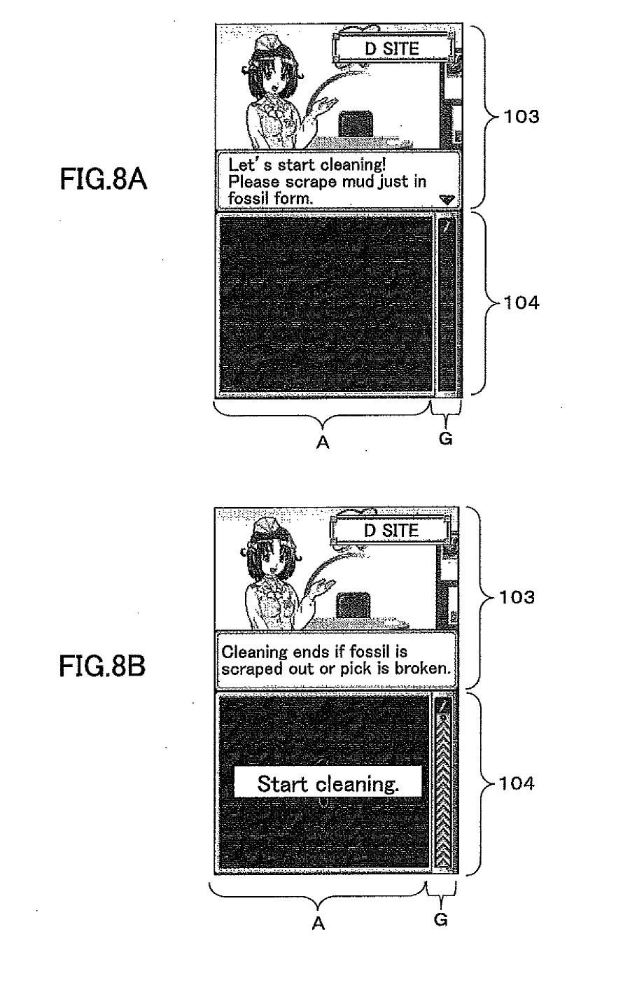

FIG. 8A is an illustration of the screen displayed first. On the screen of the main monitor 103, a character of a guide is displayed and also a message “Let's start cleaning! Please scrape mud just in fossil form.” is displayed. Because this game is supposed to be played by children, the use of difficult words is avoided. On the other hand, a cleaning area A and a gauge G of the pick for scraping the rock part are displayed on the screen of the operation part monitor 104. The cleaning area A is caused to be dark (a solid black image is superimposed) to indicate that no operation is received in this state. Then, the indication of value of the gauge G gradually goes up to indicate a progress in the preparation dramatically.

Thereafter, when the action of the gauge G going up is ended, a message “Cleaning ends if fossil is scraped out or pick is broken.” is displayed on the main monitor 103 and a message “Start cleaning” is displayed in the cleaning area A of the operation part monitor 104, as shown in FIG. 8B.

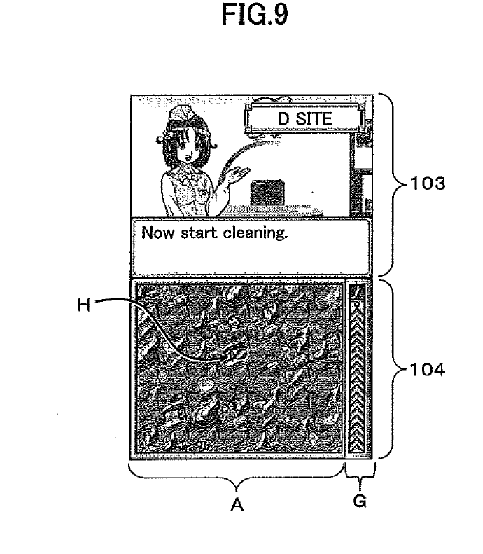

Thereafter, as shown in FIG. 9, a message “Now start cleaning.” is displayed on the main monitor 103, and the cleaning area A of the operation part monitor 104 turns into a bright display, which indicates a rock surface. It should be noted that some exposed portions H are provided at the center portion and other several portions of the rock surface in the cleaning area A.

Returning to FIG. 7, after starting the cleaning, the CPU 108 waits for an input from the touch panel 105 (step S105).

In this state, if a touch to the rock part is detected (Yes of step S106), the pick (pick pointer) is displayed at the touched portion of the screen and a process of removing the dots of the rock part corresponding to the touched portion is performed (step S107). Information regarding the removed dots is recorded in the “damaged dot” field of the state hold table T2. It should be noted that dots already removed are not removed further. Because the rock part is removed, the fossil or background image located directly under the removed rock part appears and can be seen by the player.

Subsequently, the CPU 108 determines, based on the “damaged element” field of the state hold table T2, whether the dots subjected to the rock part removing process correspond to an element which has been damaged (step S108).

If it is determined that the dots correspond to the element which has not been damaged (Yes of step S108), a pick damage process is performed (step S109). That is, the number of dots corresponding to one element is subtracted from a value retained in the “current gauge amount” field of the state hold table T2 to update the indication of the gauge G. Then, the CPU 108 determines whether the current gauge amount still remains (step S110). On the other hand, if it is determined that the dots do not correspond to an element which has not been damaged (No of step S108), the process of steps S109 and S110 is not performed.

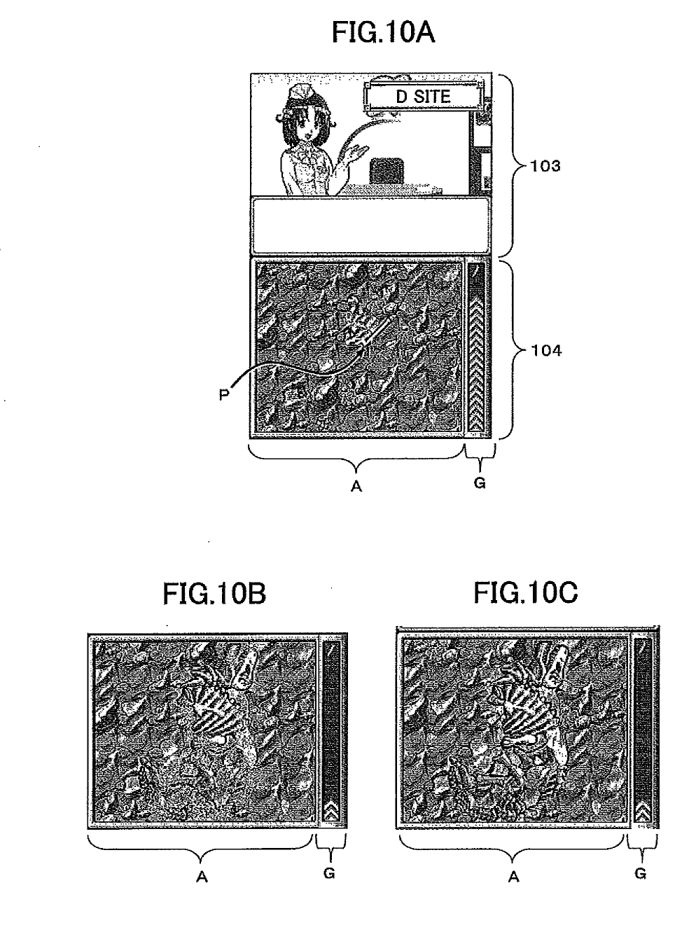

Then, if the current gauge amount still remains (Yes of step S110), or if it is not an element which has not been damaged (No of step 8108), the CPU 108 determines, based on the “form” field of the fossil data table T1, whether a place where the fossil exists has been scraped (step S111). Then, if it is determined that a place where the fossil exists has been scraped (Yes of step S111), a success effect is performed such as brightening a periphery of the scraped portion (step S112). FIG. 10A is an illustration of a screen in which the success effect is performed on portion scraped by the pick (pick pointer) P.

Subsequently, returning to FIG. 7, the CPU 108 performs a dust generation process each time a portion of the rock part corresponding to a predetermined number of dots (for example, 120 dots) is scraped (step S113). That is, an object corresponding to an image of dust is selected from previously prepared several kinds of images at random, and the CPU 108 arranges the selected objects in the periphery of the scraped portion at random. FIG. 10B is an illustration showing a screen where the dust generation has been performed. In FIG. 10B, the dust is indicated as particles of sand.

Returning to FIG. 7, after the generation of dust, the CPU 108 determines whether the fossil surface has been exposed by an area equal to or more than a predetermined ratio (for example, 83%) (step S114). If it is determined that the fossil surface has not been exposed by an area equal to or more than the predetermined ratio (No of step S114), the process returns to step S105 to wait for an input.

On the other hand, in parallel to those processes, the CPU 108 monitors an audio input, and if an audio input, such as blowing a breath onto the microphone 101, is generated (step S115), the CPU 108 performs a dust removal process (step S116). That is, all of the dust arranged on the screen is removed. FIG. 10C is an illustration of the screen where the dust removal has been performed.

Returning to FIG. 7, if it is determined that the fossil surface is exposed by an area equal to or more than the predetermined ratio (Yes of step S114), the CPU 108 determines that the game ends in success (step S117). Then, the CPU 108 determines whether the current gauge amount remains by an amount equal to or more than a predetermined ratio (for example, 15%) (step S118). If it is determined that the current gauge amount remains by the amount equal to or more than the predetermined ratio (Yes of step S118), it is determined that the player's skill corresponds to a highest rank 1 (step S119), and the game process is ended (step S125). If it is determined that the current gauge amount does not remain by the amount equal to or more than the predetermined ratio (No of step S118), it is determined that the player's skill corresponds to a rank 2 (step S120), and the game process is ended (step S125).

On the other hand, if the current gauge amount becomes zero before the fossil surface is exposed by an area corresponding to the predetermined ratio (No of step S110), the CPU 108 determines that the game ends in failure (step S121). Then, the CPU 108 determines whether the fossil surface is exposed by an area corresponding to a predetermined ratio (for example, 60%) (step S122). If it is determined that the fossil surface is exposed by an area corresponding to the predetermined ratio (Yes of step S122), the CPU 108 determines that the player's skill is a rank 3 (step S123, and the game process is ended (step S125). If it is determined that the fossil surface is not exposed by an area corresponding to the predetermined ratio (No of step S122), the CPU 108 determines that the player's skill is a lowest rank 4 (step S124), and the game process is ended (step S125).

It should be noted that an initial capacity level (capacity parameter) of a dinosaur character or an item related to a fossil appearing in a game subsequently played can be set as follows.

Rank 1 (great-success end)→Lv10

Rank 2 (success end)→Lv8

Rank 3 (failure end)→Lv6

Rank 4 (big-failure end)→Lv4

Additionally, a bonus point or penalty may be given to the initial capacity level of a dinosaur in response to the success level at the end of the cleaning. Further, an item providing an advantage in playing the game may be given if the success level is high. Additionally, the scenario of the game may be changed in response to the success level such that a success point is accumulated if the cleaning is ended in success at a high success level or the success point is deducted if the cleaning is ended in failure so that the scenario is changed in response to the accumulated success points.

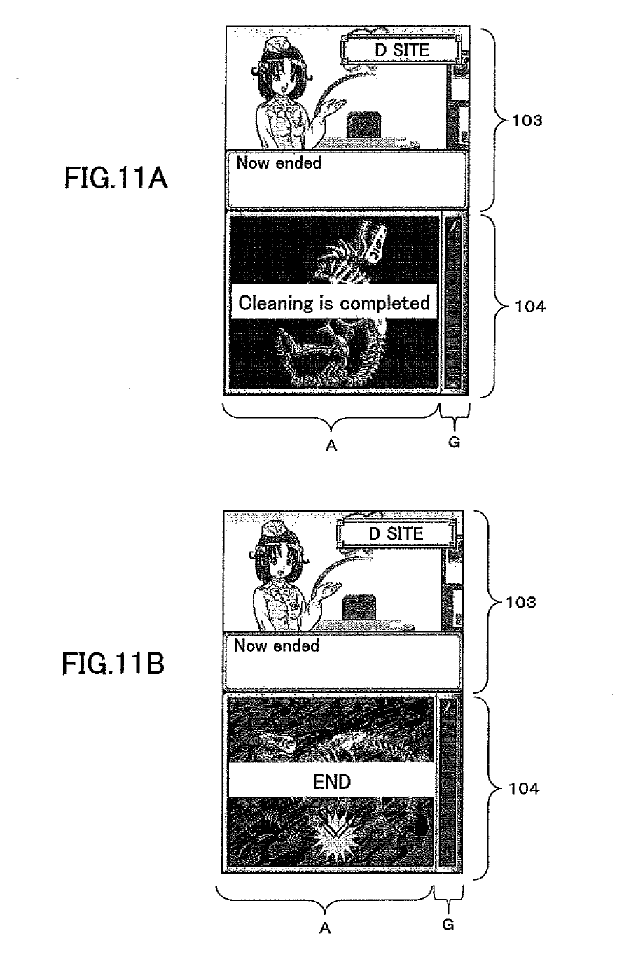

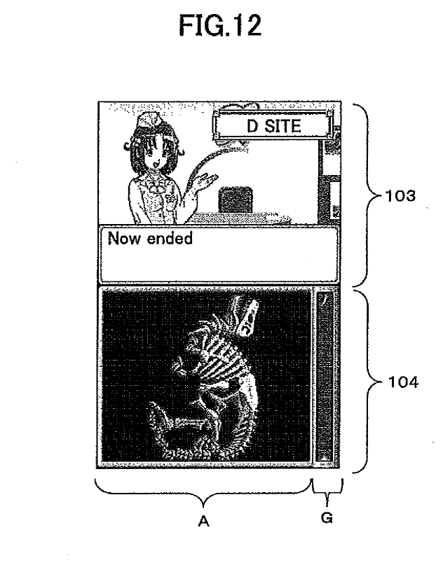

FIGS. 11A and 11B are illustrations of a display screen at the time of ending the cleaning. FIG. 11A shows a case where the fossil surface was exposed by an area equal to or more than the predetermined ratio before the current gauge amount becomes zero and the cleaning ended in success. In this case, a message “cleaning is completed” is indicated in the cleaning area A and the complete form of the fossil is displayed. FIG. 11B shows a case where the current gauge amount had become zero before the fossil surface was exposed by an area equal to or more than the predetermined ratio and the cleaning ended in failure. In this case, a message “Now ended” is indicated in the cleaning area A and the incomplete form of the fossil in the middle of cleaning and an image of the broken pick are also displayed. In either case, the complete form of the fossil is displayed finally in the cleaning area A as shown in FIG. 12.

As mentioned above, the game apparatus according to the present embodiment includes a display screen that displays a first image (fossil image) and a second image (rock image). The first image is provided with a hit determining area, and the second image is superimposed on the first image to hide the first image.

The CPU 108 of the control unit 107 of the game apparatus according to the present embodiment serves as the following functional parts in association with the program by performing the process shown in FIG. 7.

1) A position coordinate specifying part that receives an operation input of a player and specifies a position coordinate designated by the operation input.

2) A visual recognition processing part that causes the first image to appear by erasing pixels of the second image corresponding to the specified position coordinate or a predetermined area containing the specified position coordinate or applying a transparent process to the pixels, when the specified position coordinate is located within the hit determining area and when the second image exists at the position coordinate.

3) A parameter changing part that changes an operation amount parameter based on an amount of a moving operation of a position coordinate designating operation performed by the player.

4) A parameter determining part that determines whether the operation amount parameter reaches a predetermined threshold value.

5) A ratio determining part that determines whether an area of a visually recognizable portion of the first image exceeds a predetermined ratio of an area of the entire hit determining area.

6) A success determining part that determines that a game ended in success when the area of the visually recognizable portion of the first image exceeds the predetermined ratio.

7) A failure determining part that determines that a game ended in failure when the operation amount parameter reaches the predetermined threshold value before the area of the visually recognizable portion of the first image reaches the predetermined ratio.

In addition, the CPU 108 serves as the following functional parts in association with the program by performing the process shown in FIG. 7.

8) A display part that displays a gauge indicating a ratio of a current value to an initial value of the operation amount parameter.

9) A rank giving part that gives a rank to a result of the game based on a determination as to whether a ratio of a current value of the operation amount parameter to the initial value of the operation amount parameter is greater than a predetermined value. The rank giving part may give a rank based on a determination as to whether an exposure ratio of the hit determining area of the first image is larger than a predetermined value when a determination is made that the game ended in failure.

10) An initial capacity level setting part that sets an initial capacity level to a character or an item which appears in a subsequent play of the game in accordance with a level of success at a time of ending the game.

11) An item giving part that gives to the player an item which provides an advantage in playing a subsequent game in accordance with a level of success at a time of ending the game.

In the game apparatus according to the present embodiment at least one predetermined portion of the second image is partially removed beforehand so that a corresponding part of the first image located under the second image is exposed through the removed predetermined portion. The first image may be an image of a fossil of a dinosaur and the second image may be an image of a rock, and wherein an operation by the player is related to scraping the rock by a pick.

Additionally, the game control method according to the process shown in FIG. 7 may be described in a computer readable program so as to cause a computer (game apparatus) to perform the game control method. The program may be stored in a computer readable recording medium such as the external memory medium 2 shown in FIG. 1.

As mentioned above, the present embodiment provides the following advantages.

(1) In order to obtain a judgment of a high rank, the rock part must be scraped in consideration of the form of the fossil embedded under the rock part, which causes a player to pay attention to the form of the fossil in nature. Thus, the player can enjoy in observing the interesting form of the fossil.

(2) The player can memorize the form of the fossil automatically while enjoying the game. Thus, use for an educational purpose is expected.

The present invention is not limited to the specifically disclosed embodiments, and variations and modifications may be made without departing from the scope of the present invention.

The present application is based on Japanese priority application No. 2007-165595 filed Jun. 22, 2007, the entire contents of which are hereby incorporated herein by reference.

What is claimed is:

1. A game apparatus comprising:
a display screen that displays a first image and a second image, the first image being provided with a hit determining area, the second image being superimposed on the first image to hide the first image;
a position coordinate specifying part that receives an operation input of a player and specifies a position coordinate designated by the operation input;
a visual recognition processing part that causes the first image to appear by erasing pixels of the second image corresponding to the specified position coordinate or a predetermined area containing the specified position coordinate or applying a transparent process to the pixels, when the specified position coordinate is located within the hit determining area and when the second image exists at the position coordinate;
a parameter changing part that changes an operation amount parameter based on an amount of a moving operation of a position coordinate designating operation performed by the player;
a parameter determining part that determines whether the operation amount parameter reaches a predetermined threshold value;
a ratio determining part that determines whether an area of a visually recognizable portion of the first image exceeds a predetermined ratio of an area of the entire hit determining area;
a success determining part that determines that a game ended in success when the area of the visually recognizable portion of the first image exceeds the predetermined ratio; and
a failure determining part that determines that a game ended in failure when the operation amount parameter reaches the predetermined threshold value before the area of the visually recognizable portion of the first image reaches the predetermined ratio.

2. The game apparatus as claimed in claim 1, further comprising a display part that displays a gauge indicating a ratio of a current value to an initial value of the operation amount parameter.

3. The game apparatus as claimed in claim 1, further comprising a rank giving part that gives a rank to a result of the game based on a determination as to whether a ratio of a current value of the operation amount parameter to the initial value of the operation amount parameter is greater than a predetermined value.

4. The game apparatus as claimed in claim 1, wherein the rank giving part gives a rank based on a determination as to whether an exposure ratio of the hit determining area of the first image is larger than a predetermined value when a determination is made that the game ended in failure.

5. The game apparatus as claimed in claim 1, further comprising an initial capacity level setting part that sets an initial capacity level to a character or an item which appears in a subsequent play of the game in accordance with a level of success at a time of ending the game.

6. The game apparatus as claimed in claim 1, further comprising an item giving part that gives to the player an item which provides an advantage in playing a subsequent game in accordance with a level of success at a time of ending the game.

7. The game apparatus as claimed in claim 1, wherein at least one predetermined portion of the second image is partially removed beforehand so that a corresponding part of the first image located under the second image is exposed through the removed predetermined portion.

8. The game apparatus as claimed in claim 1, wherein the first image is an image of a fossil of a dinosaur and the second image is an image of a rock, and wherein an operation by the player is related to scraping the rock by a pick.

9. A game control method comprising:
displaying a first image and a second image, the first image being provided with a hit determining area, the second image being superimposed on the first image to hide the first image;
receiving an operation input of a player and specifying a position coordinate designated by the operation input;
causing the first image to appear by erasing pixels of the second image corresponding to the specified position coordinate or a predetermined area containing the specified position coordinate or applying a transparent process to the pixels, when the specified position coordinate is located within the hit determining area and when the second image exists at the position coordinate;
changing an operation amount parameter based on an amount of a moving operation of a position coordinate designating operation performed by the player;
determining whether the operation amount parameter reaches a predetermined threshold value;
determining whether an area of a visually recognizable portion of the first image exceeds a predetermined ratio of an area of the entire hit determining area;
determining that a game ended in success when the area of the visually recognizable portion of the first image exceeds the predetermined ratio; and
determining that a game ended in failure when the operation amount parameter reaches the predetermined threshold value before the area of the visually recognizable portion of the first image reaches the predetermined ratio.

10. The game control method as claimed in claim 9, further comprising displaying a gauge indicating a ratio of a current value to an initial value of the operation amount parameter.

11. The game control method as claimed in claim 9, further comprising giving a rank to a result of the game based on a determination as to whether a ratio of a current value of the operation amount parameter to the initial value of the operation amount parameter is greater than a predetermined value.

12. The game control method as claimed in claim 9, wherein the rank giving step gives a rank based on a determination as to whether an exposure ratio of the hit determining area of the first image is larger than a predetermined value when a determination is made that the game ended in failure.

13. The game control method as claimed in claim 9, further comprising setting an initial capacity level to a character or an item which appears in a subsequent play of the game in accordance with a level of success at a time of ending the game.

14. The game control method as claimed in claim 9, further comprising giving to the player an item which provides an advantage in playing a subsequent game in accordance with a level of success at a time of ending the game.

15. The game control method as claimed in claim 9, wherein at least one predetermined portion of the second image is partially removed beforehand so that a corresponding part of the first image located under the second image is exposed through the removed predetermined portion.

16. The game control method as claimed in claim 9, wherein the first image is an image of a fossil of a dinosaur and the second image is an image of a rock, and wherein an operation by the player is related to scraping the rock by a pick.

17. A computer readable recording medium storing a program to cause a computer to function as a game apparatus performing a game control method, the game control method comprising:
displaying a first image and a second image, the first image being provided with a hit determining area, the second image being superimposed on the first image to hide the first image;
receiving an operation input of a player and specifying a position coordinate designated by the operation input;
causing the first image to appear by erasing pixels of the second image corresponding to the specified position coordinate or a predetermined area containing the specified position coordinate or applying a transparent process to the pixels, when the specified position coordinate is located within the hit determining area and when the second image exists at the position coordinate;
changing an operation amount parameter based on an amount of a moving operation of a position coordinate designating operation performed by the player;
determining whether the operation amount parameter reaches a predetermined threshold value;
determining whether an area of a visually recognizable portion of the first image exceeds a predetermined ratio of an area of the entire hit determining area;
determining that a game ended in success when the area of the visually recognizable portion of the first image exceeds the predetermined ratio; and
determining that a game ended in failure when the operation amount parameter reaches the predetermined threshold value before the area of the visually recognizable portion of the first image reaches the predetermined ratio.

18. A computer readable program to cause a computer to function as a game apparatus performing a game control method, the game control method comprising:
displaying a first image and a second image, the first image being provided with a hit determining area, the second image being superimposed on the first image to hide the first image;
receiving an operation input of a player and specifying a position coordinate designated by the operation input;
causing the first image to appear by erasing pixels of the second image corresponding to the specified position coordinate or a predetermined area containing the specified position coordinate or applying a transparent process to the pixels, when the specified position coordinate is located within the hit determining area and when the second image exists at the position coordinate;
changing an operation amount parameter based on an amount of a moving operation of a position coordinate designating operation performed by the player;
determining whether the operation amount parameter reaches a predetermined threshold value;
determining whether an area of a visually recognizable portion of the first image exceeds a predetermined ratio of an area of the entire hit determining area;
determining that a game ended in success when the area of the visually recognizable portion of the first image exceeds the predetermined ratio; and
determining that a game ended in failure when the operation amount parameter reaches the predetermined threshold value before the area of the visually recognizable portion of the first image reaches the predetermined ratio.
